(19) United States
(12) Patent Application Publication
(10) Pub. No.: US 2011/0130849 A1
(43) Pub. Date: Jun. 2, 2011

(54) SENSOR ACTUATOR NODE AND METHOD FOR HANDLING CIRCUMSTANTIAL CHANGES IN SENSOR ACTUATOR NETWORK USING SAME

(75) Inventors: Sun-Jin Kim, Daejeon (KR); Junghae Seo, Daejeon (KR); Kwang Soo Kim, Daejeon (KR); Cheol Sig Pyo, Daejeon (KR); Jong-Arm Jun, Daejeon (KR); Jong-Suk Chae, Daejeon (KR)

(73) Assignee: ELECTRONICS AND TELECOMMUNICATIONS RESEARCH INSTITUTE, Daejeon (KR)

(21) Appl. No.: 12/857,101

(22) Filed: Aug. 16, 2010

(30) Foreign Application Priority Data
Dec. 2, 2009 (KR) 10-2009-0118609

(51) Int. Cl. G05B 11/01

(52) U.S. Cl. 700/12

(57) ABSTRACT

A sensor actuator node includes a sensor unit for generating sensing information on circumstantial changes; a communications unit; a countermeasure information generation unit for generating countermeasure information to the circumstantial changes; and a drive unit for driving one or more actuators. When the sensor actuator node acts as a host node, the sensing information becomes main sensing information, the countermeasure information generation unit generates the countermeasure information based on the main sensing information and selectively transmits the countermeasure information to the adjacent sensor actuator nodes via the communications unit, and the drive unit drives the actuator based on the countermeasure information. When the sensor actuator node acts as a non-host node, the sensing information becomes auxiliary sensing information, and the drive unit drives the actuator based on the countermeasure information selectively transmitted thereto by the host node.

### CROSS-REFERENCE(S) TO RELATED APPLICATION(S)

The present invention claims priority to Korean Patent Application No. 10-2009-0118609, filed on Dec. 2, 2009, which is incorporated herein by reference.

### FIELD OF THE INVENTION

The present invention relates to a sensor actuator node and a method for handling circumstantial changes in a sensor actuator network; and, more particularly, to a sensor actuator node and a method for handling circumstantial changes in a sensor actuator network using the same, wherein the sensor actuator node itself generates countermeasures to circumstantial changes in the whole sensor actuator network based on local sensing information, i.e., without receiving the countermeasures from a central control server of the sensor actuator network, thereby handling the changes rapidly.

### BACKGROUND OF THE INVENTION

A WSN (Wireless Sensor Network) generally called as a sensor network includes sensor nodes and at least one sink node. Each sensor node has sensors and small-sized wireless transceiver to transmit sensing data to the sink node. The sink node collects information from the sensor nodes and transmits the information to outside.

The sink node is a relay node accessed by the sensor nodes to communicate with an external network, and also referred to as a gateway or a base station. Although the sink nodes, the gateway and the base station may be distinguished from one another by their function, they are the same in that they are located at the contact point between an external network and a sensor network.

That is, in a conventional sensor network, data sensed by a plurality of sensor nodes is collected by a designated sink node and the data collected by the sink node is transmitted to a server.

FIG. 1 illustrates a flowchart of an exemplary procedure for recognizing and handling circumstantial changes in a conventional sensor network.

First, as shown in FIG. 1, sensor nodes sense a variety of types of information and transmit the sensing information to a designated sink node (step 1). The sink node collects information provided by the sensor nodes and transmits thus collected information to a control center (step 2). The control center determines, based on the information received from the sink node, whether an event occurs at a place where each sensor node locates (step 3). When it is determined that an event requiring countermeasures to be taken occurs, the control center takes the countermeasures (steps 4 and 5). For example, the control center makes an emergency call to a fire station in case of a fire and makes an emergency call to a police station in case of an illegal intrusion.

As described above, in the conventional sensor network, collected information should be transmitted to the control center in order to recognize circumstantial changes at a place where each sensor node locates, which hinders rapid event recognition. Further, since countermeasures to handle the circumstantial changes cannot be taken actively in the sensor network, only passive countermeasures such as a report can be taken even if occurrence of an event is recognized rapidly.

### SUMMARY OF THE INVENTION

In view of the above, the present invention provides a sensor actuator node and a method for handling circumstantial changes in a sensor actuator network using the same, wherein the sensor actuator node itself generates countermeasures to circumstantial changes in the sensor actuator network based on local sensing information, i.e., without receiving the countermeasures from a central control server of the sensor actuator network, thereby handling the changes rapidly.

In accordance with an aspect of the present invention, there is provided a sensor actuator node in a sensor actuator network, wherein the sensor actuator node operates at least one device by driving an actuator of each device and acts as at least one of a host node and a non-host node at a time, the sensor actuator node including:

a sensor unit for sensing circumstantial changes and generating sensing information on the circumstantial changes;

a communications unit for communicating with adjacent sensor actuator nodes;

a countermeasure information generation unit for generating countermeasure information to the circumstantial changes; and

a drive unit for driving the actuator,

wherein when the sensor actuator node acts as the host node, the sensing information generated by the sensor unit becomes main sensing information, the countermeasure information generation unit generates the countermeasure information based on the main sensing information and selectively transmits the countermeasure information to the adjacent sensor actuator nodes via the communications unit, and the drive unit drives the actuator based on the countermeasure information; and

wherein when the sensor actuator node acts as the non-host node, the sensing information generated by the sensor unit becomes auxiliary sensing information, and the drive unit drives the actuator based on the countermeasure information selectively transmitted thereto by the host node.

Preferably, when the sensor actuator node acts as the host node, the countermeasure information generation unit selectively requests, via the communications unit, the adjacent sensor actuator nodes to transmit the auxiliary sensing information and generates the countermeasure information based on the main sensing information and the auxiliary sensing information.

The sensor actuator node may further include a node database for storing therein location information on locations of sensor actuator nodes in the sensor actuator network, sensing target information on sensing targets of the sensor actuator nodes and device information on devices associated with the sensor actuator nodes.

Preferably, when the sensor actuator node acts as the host node, the countermeasure information generation unit selects, based on the main sensing information and the sensing target information stored in the node database, one or more adjacent sensor actuator nodes and requests the selected sensor actuator nodes to transmit the auxiliary sensing information.

Preferably, when the sensor actuator node acts as the host node, the countermeasure information generation unit selects, by using the location information stored in the node database, one or more adjacent sensor actuator nodes within a specific distance from the sensor actuator node and requests the selected sensor actuator nodes to transmit the auxiliary sensing information.

Preferably, when the sensor actuator node acts as the host node, the countermeasure information generation unit generates the countermeasure information based on the main sensing information, the auxiliary sensing information and the device information stored in the node database.

The sensor actuator node may further include an editing unit for communicating with an external control server via the communications unit to receive data relating to the location information, the sensing target information and the device information from the control server and updating the node database based on the received data.

Preferably, the drive unit includes a conversion unit for converting the countermeasure information to be in compliance with a protocol for the actuator.

Preferably, when the sensor actuator node acts as the host node, the countermeasure information generation unit collects, after the actuators of the host node and the adjacent sensor actuator nodes have been driven based on the countermeasure information, new main sensing information generated by the sensor unit and new auxiliary sensing information of the adjacent sensor actuator nodes, and then based on the new main sensing information and the new auxiliary sensing information, generates event handling result information on results of handling the circumstantial changes according to the countermeasure information.

Preferably, when the sensor actuator node acts as the host node, the countermeasure information generation unit generates new countermeasure information based on the event-handling result information and selectively transmits the new countermeasure information to the adjacent sensor actuator nodes.

Preferably, when the sensor actuator node acts as the non-host, the countermeasure information generation unit transmits the auxiliary sensing information to the host node in response to a request for the auxiliary sensing information from the host node.

In accordance with another aspect of the present invention, there is provided a method for handling circumstantial changes in a sensor actuator network, including:

selecting at least one host node among sensor actuator nodes in the sensor actuator network;

sensing, at the host node, the circumstantial changes to generate main sensing information based on the circumstantial changes;

generating, at the host node, countermeasure information to handle the circumstantial changes based on the main sensing information;

selecting, at the host node, one or more operation nodes among the sensor actuator nodes;

transmitting, at the host node, the countermeasure information to the operation nodes; and

operating, at each of the operation nodes, one or more devices associated with the operation node based on the countermeasure information.

Preferably, said generating the countermeasure information includes selecting one or more adjacent nodes among the sensor actuator nodes adjacent to the host node; requesting the selected nodes to transmit auxiliary sensing information; and generating the countermeasure information based on the main sensing information and the auxiliary sensing information.

Preferably, each of the sensor actuator nodes includes a node database for storing therein sensing target information on sensing targets of adjacent sensor actuator nodes; and wherein the host node selects said one or more adjacent nodes based on the main sensing information and the sensing target information stored in the node database.

Preferably, each of the sensor actuator nodes includes a node database for storing therein location information on locations of adjacent sensor actuator nodes; and the host node selects said one or more adjacent nodes based on the location information stored in the node database

Preferably, each of the sensor actuator nodes includes a node database for storing therein device information on devices associated with the sensor actuator nodes in the sensor actuator network; and the host node generates the countermeasure information based on the main sensing information and the auxiliary sensing information and the device information stored in the node database

Preferably, each of the sensor actuator nodes includes a node database for storing therein sensing target information on sensing targets of the sensor actuator nodes in the sensor actuator network, location information on locations of the sensor actuator nodes and device information on devices associated with the sensor actuator nodes; and said each of the sensor actuator nodes receives from an external control server the sensing target information, the location information and the device information and updates the node database based on the information received from the control server.

The method may further include selecting, at the host node after said operating one or more devices, one or more sensor actuator nodes and collecting new sensing information of thus selected sensor actuator nodes; and generating, at the host node, event-handling result information on results of handling the circumstantial changes according to the countermeasure information based on the new sensing information.

The method may further include generating, at the host node, new countermeasure information based on the event-handling result information; and selectively transmitting the new countermeasure information to the sensor actuator nodes.

Preferably, said operating the device includes converting the countermeasure information to be in compliance with a protocol for the device; and operating the device by using the converted countermeasure information.

According to the present invention, when a sensor actuator node detects circumstantial changes based on sensing information thereof, the sensor actuator node requests sensing information of adjacent sensor actuator nodes to determine countermeasures to handle the changes and then transmits the countermeasures to the adjacent sensor actuator nodes to drive actuators of devices, thereby handling the changes. That is, since an event requiring countermeasures to be taken can be handled without a help of a control center, rapid countermeasures can be taken when an emergency event occurs.

Furthermore, according to the present invention, since results of handling the circumstantial changes are reported to the control server after countermeasures are taken by the sensor actuator nodes, follow-up countermeasures, e.g., medical treatment of casualties, which cannot be provided by the sensor actuator nodes can be also taken.

### BRIEF DESCRIPTION OF THE DRAWINGS

The above and other objects and features of the present invention will become apparent from the following description of embodiments given in conjunction with the accompanying drawings, in which:

FIG. 1 illustrates a flowchart of an exemplary procedure for recognizing and handling circumstantial changes in a conventional sensor network;

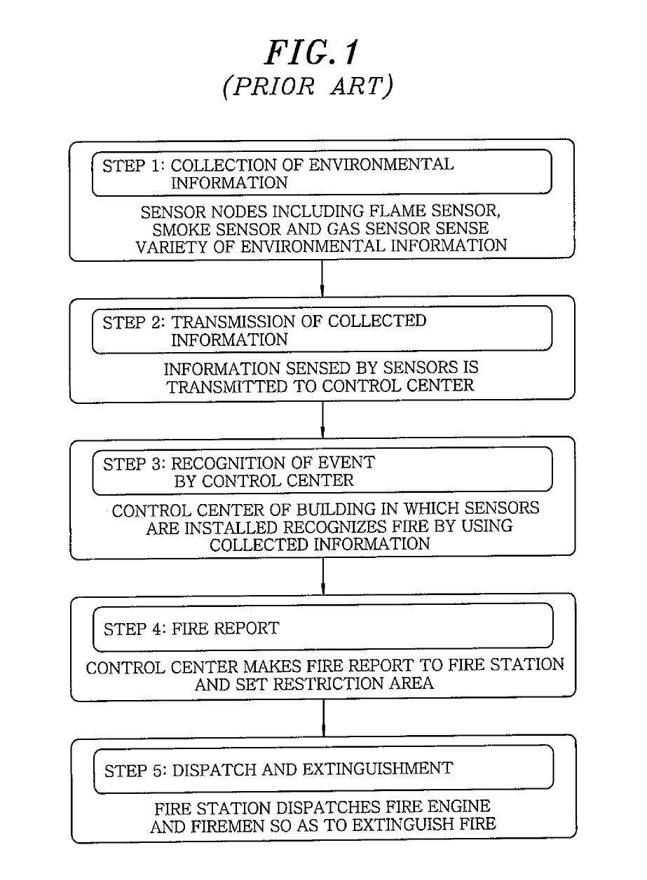

FIG. 2 illustrates a block diagram of a sensor actuator node in accordance with an embodiment of the present invention; and

FIG. 3 illustrates a flowchart of a method for handling circumstantial changes in a sensor actuator network using the sensor actuator nodes of FIG. 2.

### DETAILED DESCRIPTION OF THE EMBODIMENTS

Hereinafter, embodiments of the present invention will be described in detail with reference to the accompanying drawings, which form a part hereof.

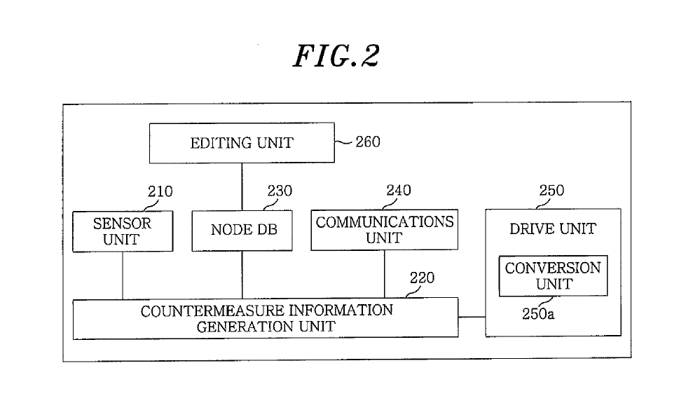

FIG. 2 illustrates a block diagram of a sensor actuator node in accordance with an embodiment of the present invention. The sensor actuator node includes a sensor unit 210, a countermeasure information generation unit 220, a node database (DB) 230, a communications unit 240, a drive unit 250 and an editing unit 260.

The sensor unit 210 performs a sensing function which is one of basic functions of the sensor actuator node. The sensor unit 210 can sense a variety of phenomena or materials to detect a variety of circumstantial changes. The sensor unit 210 generates main sensing information as a result of the sensing function and provides thus generated main sensing information to the countermeasure information generation unit 220.

Sensing targets of the sensor unit 210 are the same as those of a conventional sensor node and may include light, heat and vibration. Further, when necessary, the sensor unit 210 may be set such that it can sense infrared rays, gas, a flame or an image.

The countermeasure information generation unit 220 receives the main sensing information from the sensor unit 210 and requests sensing information of adjacent sensor actuator nodes based on the main sensing information. That is, when receiving the main sensing information from the sensor unit 210, the countermeasure information generation unit 220 selectively requests the adjacent sensor actuator nodes to transmit auxiliary sensing information. When receiving the auxiliary sensing information from the adjacent sensor actuator nodes, the countermeasure information generation unit 220 determines whether an event, i.e., circumstantial changes, requiring countermeasures to be taken occurs based on the main sensing information received from the sensor unit 210 and the auxiliary sensing information received from the adjacent sensor actuator nodes and then generates countermeasure information to handle the event.

Meanwhile, the countermeasure information generation unit 220 may generate countermeasure information by using the main sensing information only.

Hereinafter, for convenience of explanation, a sensor actuator node which generates countermeasure information will be referred to as “host node”. Further, a sensor actuator node which receives the countermeasure information from a host node will be referred to as “non-host node”. Accordingly, for an event, a sensor actuator node may act as a host node or a non-host node. Here, it should be noted that a sensor actuator node can simultaneously act as a host node for an event and as a non-host node for other event.

The node DB 230 stores therein location information and sensing target information of each sensor actuator node.

Based on the information stored in the node DB 230, the countermeasure information generation unit 220 may select one or more sensor actuator nodes adjacent to the host node to request sensing information of the selected nodes. To be specific, the countermeasure information generation unit 220 may select nodes having sensing targets relating to the main sensing information provided by the sensor unit 210 or nodes located within a specific distance from the host node.

That is, the countermeasure information generation unit 220 selects sensor actuator nodes based on the main sensing information provided by the sensor unit 210 and the information stored in the node DB 230, and then requests the selected sensor actuator nodes to transmit auxiliary sensing information. For example, if the main sensing information relates to detection of an abnormal temperature, the countermeasure information generation unit 220 searches the node DB 230 to select sensor actuator nodes having auxiliary sensing information necessary for determination of an occurrence of a fire and requests only the selected sensor actuator nodes, not all sensor actuator nodes within the sensor network, to transmit auxiliary sensing information.

Further, the countermeasure information generation unit 220 may calculate the distances between the host node and the adjacent sensor actuator nodes based on the location information stored in the node DB 230 to assign weights to the adjacent sensor actuator nodes based on the calculated distances and select sensor actuator nodes according to the assigned weights.

The node DB 230 further stores therein device information on devices which can be driven by each sensor actuator node. For example, when a specific sensor actuator node is operated in conjunction with a fire extinguisher or a sprinkler, the device information associated with the specific sensor actuator node denotes the fire extinguisher or the sprinkler.

The information stored in the node DB 230, i.e., the location information, the sensing target information and the device information of sensor actuator nodes, can be updated by using OTAP (Over-the-air provisioning). That is, the node DB 230 can be updated with information received from a control server (not shown) via the communications unit 240.

An update process on the information stored in the node DB 230 is performed by the editing unit 260. That is, the editing unit 260 communicates with the control server via the communications unit 240 to receive the location information, the sensing target information and the device information of sensor actuator nodes communicating with the control server. Based on the received information from the control server, the editing unit 260 adds, modifies or deletes information stored in the node DB 230.

The countermeasure information generation unit 220 determines whether an event occurs based on the auxiliary sensing information received from the adjacent sensor actuator nodes and the main sensing information, and generates countermeasure information in case of an occurrence of an event requiring countermeasures to be taken. The countermeasure information generated can be provided to the control server via the communications unit 240.

Meanwhile, when generating the countermeasure information based on the main sensing information and the auxiliary sensing information, the countermeasure information generation unit 220 may refer to the node DB 230. That is, when a fire is detected, the countermeasure information generation unit 220 may search the node DB 230 to find sensor actuator nodes which are associated with fire-related devices and generate countermeasure information to drive the devices.

Furthermore, the countermeasure information generation unit 220 may transmit the main sensing information to the adjacent sensor actuator nodes in response to requests from the adjacent sensor actuator nodes.

The drive unit 250 is operated in conjunction with one or more actuators of devices which can be connected to and driven by the sensor actuator node. That is, the drive unit 250 operates one or more devices by driving the actuators based on the countermeasure information generated by the countermeasure information generation unit 220 of the host node.

The drive unit 250 includes a conversion unit 250a for converting the countermeasure information to be in compliance with a protocol for the actuator of the device which is operated in conjunction with the sensor actuator node. By converting the countermeasure information via the conversion unit 250a, the drive unit 250 can drive the actuator of the device based on the countermeasure information.

The communications unit 240 has a wired and/or wireless communications interface for transmitting and receiving the sensing information, the countermeasure information and other countermeasure-related information to and from the adjacent sensor actuator nodes or the control server.

According to the embodiment of the present invention, the host node, which may be a sensor actuator node first detecting an occurrence of an event and generate the main sensing information, can analyze circumstantial changes in the whole sensor actuator network and generate countermeasures to the changes by using local sensing information, i.e., the main sensing information only or along with the auxiliary sensing information received from the sensor actuator nodes adjacent to the host node.

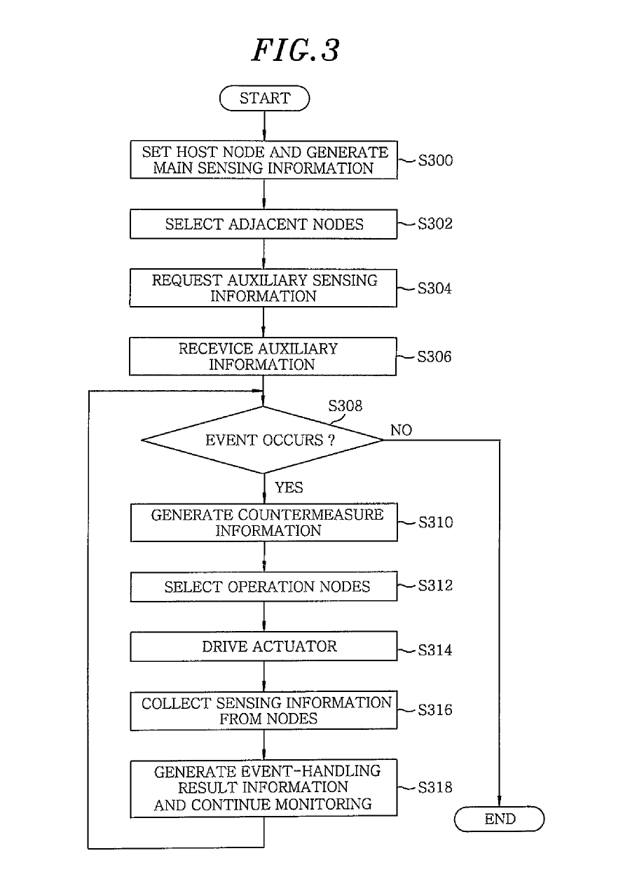

Below, a method for handling circumstantial changes in a sensor actuator network using the above-described sensor actuator nodes will be described with reference to FIG. 3.

FIG. 3 illustrates a flowchart of a method for handling circumstantial changes in a sensor actuator network using the sensor actuator nodes of FIG. 2.

Referring to FIG. 3, when a sensor actuator node in a sensor actuator network detects circumstantial changes via the sensor unit 210, the sensor actuator node becomes a host node and generates main sensing information on the changes (step S300).

Thereafter, the countermeasure information generation unit 220 of the host node selects, based on the main sensing information and by using the information stored in the node DB 230, adjacent sensor actuator nodes from which auxiliary sensing information will be received (step S302). To be specific, the countermeasure information generation unit 220 may compare the main sensing information and the sensing target information stored in the node DB 230 to select nodes having sensing targets relating to the sensing target of the host node, or select nodes within a specific distance from the host node by using the location information stored in the node DB 230.

After that, the countermeasure information generation unit 220 requests the selected adjacent sensor actuator nodes to transmit auxiliary sensing information via the communications unit 240 (step S304) and then receives the auxiliary sensing information from the adjacent sensor actuator nodes (step S306).

The countermeasure information generation unit 220 of the host node analyzes the auxiliary sensing information and the main sensing information to determine whether an event, i.e., circumstantial changes requiring countermeasures to be taken, occurs (step S308).

As describe above, the countermeasure information generation unit 220 may determine whether an event occurs by using only the main sensing information sensed by the host node.

If it is determined in the step S308 that an event to which countermeasures need to be taken occurs, the countermeasure information generation unit 220 of the host node generates countermeasure information based on the auxiliary sensing information, the main sensing information and the information stored in the node DB 230 (step S310). Here, the countermeasure information may be generated based on the device information stored in the node DB 230, the auxiliary sensing information and the main sensing information.

After generating the countermeasure information in the step S310, the countermeasure information generation unit 220 selects operation nodes, among the sensor actuator nodes, which operate in conjunction with devices necessary for taking countermeasures contained in the generated countermeasure information (step S312). The criteria for selecting the operation nodes in the step S312 may be based on the location information and the device information stored in the node DB 230.

After selecting the operation nodes in the step S312, the countermeasure information generation unit 220 transmits the countermeasure information to the selected operation nodes. Each of the operation nodes drives the actuator of the device by using the drive unit 250 thereof, thereby handling the event (step S314).

Meanwhile, the host node itself can be an operation node, and in such case, the host node also drives its actuator by using its drive unit 250 according to the countermeasure information generated by the countermeasure information generation unit 220.

After event-handling is completed in the step S314, the host node selects one or more sensor actuator nodes including the host itself and collects new sensing information from the selected sensor actuator node (step S316).

The countermeasure information generation unit 220 generates event handling result information on results of handling the event based on the countermeasure information and the new sensing information collected in the step S316, and then the control returns to the step S308 (step S318).

If it is determined in the step S308 that an event to which countermeasures need to be taken does not occur, the event-handling is terminated.

Though not shown in FIG. 3, the countermeasure information generation unit 220 of the host node may report an occurrence of an event, the countermeasure information and event-handling result information to the control server via the communications unit 240. Further, the operation nodes may report to the control server results of driving the devices according to the countermeasure information. From such reports, the control server can recognize the occurrence of the event and the countermeasures taken locally by the host node and can take follow-up countermeasures which cannot be taken locally by the host node, e.g., medical treatment of casualties.

While the invention has been shown and described with respect to the embodiments, it will be understood by those skilled in the art that various changes and modifications may be made without departing from the scope of the invention as defined in the following claims.

What is claimed is:

1. A sensor actuator node in a sensor actuator network, wherein the sensor actuator node operates at least one device by driving an actuator of each device and acts as at least one of a host node and a non-host node at a time, the sensor actuator node comprising:
a sensor unit for sensing circumstantial changes and generating sensing information on the circumstantial changes;
a communications unit for communicating with adjacent sensor actuator nodes;
a countermeasure information generation unit for generating countermeasure information to the circumstantial changes; and
a drive unit for driving the actuator,
wherein when the sensor actuator node acts as the host node, the sensing information generated by the sensor unit becomes main sensing information, the countermeasure information generation unit generates the countermeasure information based on the main sensing information and selectively transmits the countermeasure information to the adjacent sensor actuator nodes via the communications unit, and the drive unit drives the actuator based on the countermeasure information; and
wherein when the sensor actuator node acts as the non-host node, the sensing information generated by the sensor unit becomes auxiliary sensing information, and the drive unit drives the actuator based on the countermeasure information selectively transmitted thereto by the host node.

2. The sensor actuator node of claim 1, wherein when the sensor actuator node acts as the host node, the countermeasure information generation unit selectively requests, via the communications unit, the adjacent sensor actuator nodes to transmit the auxiliary sensing information and generates the countermeasure information based on the main sensing information and the auxiliary sensing information.

3. The sensor actuator node of claim 2, further comprising:
a node database for storing therein location information on locations of sensor actuator nodes in the sensor actuator network, sensing target information on sensing targets of the sensor actuator nodes and device information on devices associated with the sensor actuator nodes.

4. The sensor actuator node of claim 3, wherein when the sensor actuator node acts as the host node, the countermeasure information generation unit selects, based on the main sensing information and the sensing target information stored in the node database, one or more adjacent sensor actuator nodes and requests the selected sensor actuator nodes to transmit the auxiliary sensing information.

5. The sensor actuator node of claim 3, wherein when the sensor actuator node acts as the host node, the countermeasure information generation unit selects, by using the location information stored in the node database, one or more adjacent sensor actuator nodes within a specific distance from the sensor actuator node and requests the selected sensor actuator nodes to transmit the auxiliary sensing information.

6. The sensor actuator node of claim 3, wherein when the sensor actuator node acts as the host node, the countermeasure information generation unit generates the countermeasure information based on the main sensing information, the auxiliary sensing information and the device information stored in the node database.

7. The sensor actuator node of claim 3, further comprising:
an editing unit for communicating with an external control server via the communications unit to receive data relating to the location information, the sensing target information and the device information from the control server and updating the node database based on the received data.

8. The sensor actuator node of claim 1, wherein the drive unit includes a conversion unit for converting the countermeasure information to be in compliance with a protocol for the actuator.

9. The sensor actuator node of claim 1, wherein when the sensor actuator node acts as the host node, the countermeasure information generation unit collects, after the actuators of the host node and the adjacent sensor actuator nodes have been driven based on the countermeasure information, new main sensing information generated by the sensor unit and new auxiliary sensing information of the adjacent sensor actuator nodes, and then based on the new main sensing information and the new auxiliary sensing information, generates event handling result information on results of handling the circumstantial changes according to the countermeasure information.

10. The sensor actuator node of claim 9, wherein when the sensor actuator node acts as the host node, the countermeasure information generation unit generates new countermeasure information based on the event-handling result information and selectively transmits the new countermeasure information to the adjacent sensor actuator nodes.

11. The sensor actuator node of claim 1, wherein when the sensor actuator node acts as the non-host node, the countermeasure information generation unit transmits the auxiliary sensing information to the host node in response to a request for the auxiliary sensing information from the host node.

12. A method for handling circumstantial changes in a sensor actuator network, comprising:
selecting at least one host node among sensor actuator nodes in the sensor actuator network;
sensing, at the host node, the circumstantial changes to generate main sensing information based on the circumstantial changes;
generating, at the host node, countermeasure information to handle the circumstantial changes based on the main sensing information;
selecting, at the host node, one or more operation nodes among the sensor actuator nodes;
transmitting, at the host node, the countermeasure information to the operation nodes; and
operating, at each of the operation nodes, one or more devices associated with the operation node based on the countermeasure information.

13. The method of claim 12, wherein said generating the countermeasure information includes:
selecting one or more adjacent nodes among the sensor actuator nodes adjacent to the host node;
requesting the selected nodes to transmit auxiliary sensing information; and
generating the countermeasure information based on the main sensing information and the auxiliary sensing information.

14. The method of claim 13, wherein each of the sensor actuator nodes includes a node database for storing therein sensing target information on sensing targets of adjacent sensor actuator nodes; and wherein the host node selects said one or more adjacent nodes based on the main sensing information and the sensing target information stored in the node database.

15. The method of claim 13, wherein each of the sensor actuator nodes includes a node database for storing therein location information on locations of adjacent sensor actuator nodes; and wherein the host node selects said one or more adjacent nodes based on the location information stored in the node database

16. The method of claim 13, wherein each of the sensor actuator nodes includes a node database for storing therein device information on devices associated with the sensor actuator nodes in the sensor actuator network; and wherein the host node generates the countermeasure information based on the main sensing information and the auxiliary sensing information and the device information stored in the node database

17. The method of claim 13, wherein each of the sensor actuator nodes includes a node database for storing therein sensing target information on sensing targets of the sensor actuator nodes in the sensor actuator network, location information on locations of the sensor actuator nodes and device information on devices associated with the sensor actuator nodes; and wherein said each of the sensor actuator nodes receives from an external control server the sensing target information, the location information and the device information and updates the node database based on the information received from the control server.

18. The method of claim 12, further comprising:
selecting, at the host node after said operating one or more devices, one or more sensor actuator nodes and collecting new sensing information of thus selected sensor actuator nodes; and
generating, at the host node, event-handling result information on results of handling the circumstantial changes according to the countermeasure information based on the new sensing information.

19. The method of claim 18, further comprising:
generating, at the host node, new countermeasure information based on the event-handling result information; and
selectively transmitting the new countermeasure information to the sensor actuator nodes.

20. The method of claim 12, wherein said operating the device includes:
converting the countermeasure information to be in compliance with a protocol for the device; and
operating the device by using the converted countermeasure information.
